(19) United States
(12) Patent Application Publication
(10) Pub. No.: US 2012/0280070 A1
(43) Pub. Date: Nov. 8, 2012

(54) HORIZONTALLY-FED PAPER SHREDDER WITH TURNOVER COVER

(76) Inventor: Huize Wang, Dongguan City (CN)

(21) Appl. No.: 13/499,040

(22) PCT Filed: Mar. 18, 2010
(86) PCT No.: PCT/CN2010/071137

§ 371 Date: Mar. 29, 2012

(30) Foreign Application Priority Data
Feb. 8, 2010 (CN) 201020115726.7

(51) Int. Cl. B02C 23/02; B02C 23/04

(52) U.S. Cl. 241/33; 241/285.1

(57) ABSTRACT

This invention pertains to the category of the paper shredder technology, more particularly, the invention relates to a horizontally-fed shredder with turnover cover, comprising a cutting head, a shredding slot that is disposed on the top of the cutting head and cutters that are disposed under the shredding slot, wherein on the top of the cutting head is disposed with a turnover cover, the turnover cover and the top of the cutting head form a paper entry therebetween to connect the shredding slot. The horizontally-fed shredder with a turnover cover provided herein has the advantages of greater convenience and safety, and meanwhile it is capable of effectively preventing paper obstruction or jamming and has people-oriented design.

### TECHNICAL FIELD OF THE INVENTION

This invention pertains to the category of the paper shredder technology, more particularly, the invention relates to a horizontally-fed paper shredder with turnover cover.

### BACKGROUND OF THE INVENTION

Conventionally, paper shredders are widely used in offices or families. They can cut papers into fine pieces, typically in debris, particles, segments, foams or strips. For this reason, paper shredders are usually applied to shred important documents for safety concerns.

Whether paper shredders are used in offices or families, they are required to be highly convenient and reliable and with less space. For instance, in order to facilitate accessibility and space saving, paper shredders are conventionally placed under office tables for shredding while at working positions. However, the shredding slot of paper shredders frequently seen on the market is located on the top of the cutting head and cutters are disposed under the shredding slot. In addition, as the shredding slot faces upwards, vertical feeding is required. When users intend to carry out shredding, papers need to be fed in a more vertical manner. In this case, the space above the shredder must be sufficient enough for vertical feeding. Consequently this may cause problems to some places where there is no sufficient space above the shredder, therefore conventional shredders show much inconvenience for users and they are likely to be obstructed or jammed. Furthermore, the shredding slot of such shredders is usually open, resulting in huge potential safety hazards that ties, hairs or fingers (especially children's) are highly likely to be pulled into the shredding slot during shredding. Even if shredding slot is reduced by manufactures due to safety certification concerns, the aforesaid potential safety hazards are still inevitable and the safety cannot be further improved. In addition, such shredders are not people-oriented and papers are difficult to be aligned with the shredding slot.

### SUMMARY OF THE INVENTION

In view of the abovementioned problems, it is one object of the invention to overcome the drawbacks of the prior art by providing a horizontally-fed paper shredder with turnover cover, which is characterized in that it is more convenient and reliable and capable of effectively preventing paper obstruction or jamming and has people-oriented design.

To achieve aforesaid. object, the adopted technical solution is described below:

A horizontally-fed paper shredder with turnover cover, in accordance with the invention invention, comprises a cutting head, a shredding slot is disposed on the top of the cutting head, and cutters are disposed under the shredding slot, wherein on the top of the cutting head is disposed with a turnover cover, and the turnover cover and the top of the cutting head form a paper entry therebetween to connect the shredding slot.

The rear end of the turnover cover is located over the shredding slot proximate one of the paper entry and above the shredding slot is disposed with a decorative plate that is fixed on the top of the cutting head.

Said decorative plate is a transparent or semi-transparent plate.

The rear end of said turnover cover is disposed above the shredding slot.

The front end of the turnover cover is an arc-shaped end bending upwards.

The top of the cutting head is disposed with a panel, the turnover cover and the panel form a paper entry therebetween, and the upper surface of the panel inclines downwards from the paper entry to the shredding slot.

The underside of said turnover cover is disposed with a roller assembly for paper feeding, the roller assembly is located between the paper entry and the shredding slot and it is composed of two rollers drivingly connected via a gear mechanism. Both ends of the two rollers are axially connected with the underside of the cover and a dimensionally adjustable aperture is formed between the two rollers.

The turnover cover and the top of the cutting head are cooperatively arranged with a self-locking device.

A paper feeding detector switch is disposed at the paper entry that is on the top of the cutting head.

The turnover cover is a transparent or semi-transparent plate.

Advantages of this invention are described as follows: The invention provides a horizontally-fed shredder with turnover cover. Cutter are disposed under the shredding slot, on the top of the cutting head is disposed a turnover cover, the turnover cover and the top of the cutting head form a paper entry therebetween to connect the shredding slot. For above described paper shredder, horizontal feeding is adopted, where papers are fed horizontally into the paper entry and then shredded by cutters. Accordingly, the horizontally-fed shredder provided by the invention has low requirement on spaces, making it highly convenient for the horizontally-fed shredder to be used under some special circumstances such us under office tables. With such shredders, users can easily feed papers into the paper entry in a horizontal manner and carry out shredding with little effort. Optionally, the turnover cover can be designed to cover the shredding slot while the paper shredding is in progress, so that ties, hairs or fingers will not be pulled into the shredding slot. In this way, potential safety hazards are largely reduced and shredder safety is improved, and meanwhile it is capable of effectively preventing paper obstruction or jamming and has people-oriented design.

### BRIEF DESCRIPTION OF THE DRAWINGS

FIG. 1 is a structural representation of a horizontally-fed shredder with turnover cover in accordance with example 1 of the present invention with the turnover cover placed horizontally;

FIG. 2 is a structural representation of the horizontally-fed shredder with turnover cover in accordance with example 1 of the present invention with the turnover cover turned over;

FIG. 3 is a longitudinally sectional view of the horizontally-fed shredder with turnover cover in accordance with example 1 of the present invention;

FIG. 4 is a structural representation of the turnover cover and the roller assembly of the horizontally-fed shredder with turnover cover in accordance with example 1 of the present invention;

FIG. 5 is a longitudinally sectional view of the horizontally-fed shredder with turnover cover in accordance with example 2 of the present invention; and

FIG. 6 is a structural representation of the horizontally-fed shredder with turnover cover in accordance with example 3 of the present invention with the turnover cover turned over.

### DETAILED DESCRIPTION OF THE EMBODIMENTS

The present invention is explained in further detail below with reference to the attached drawings.

### Example 1

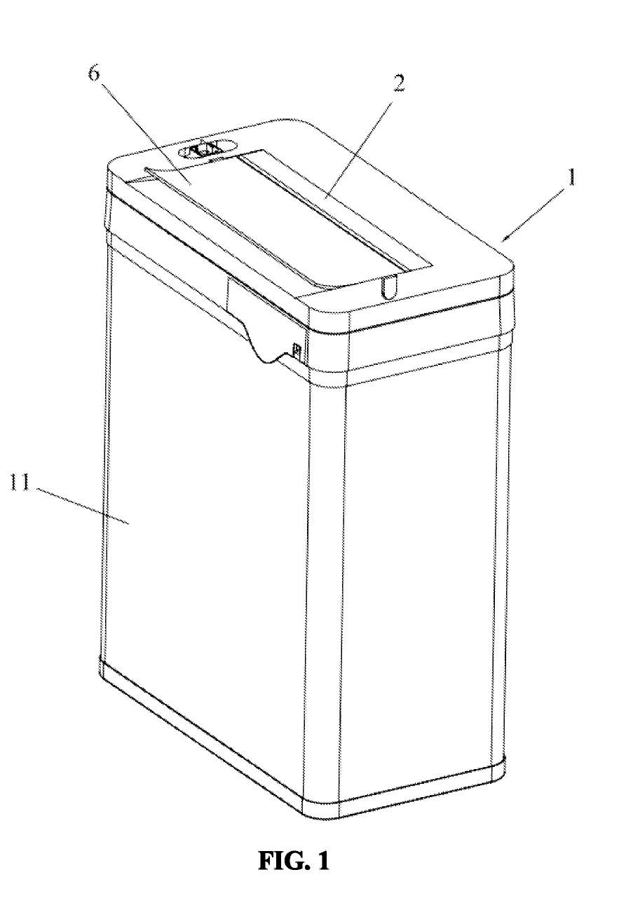

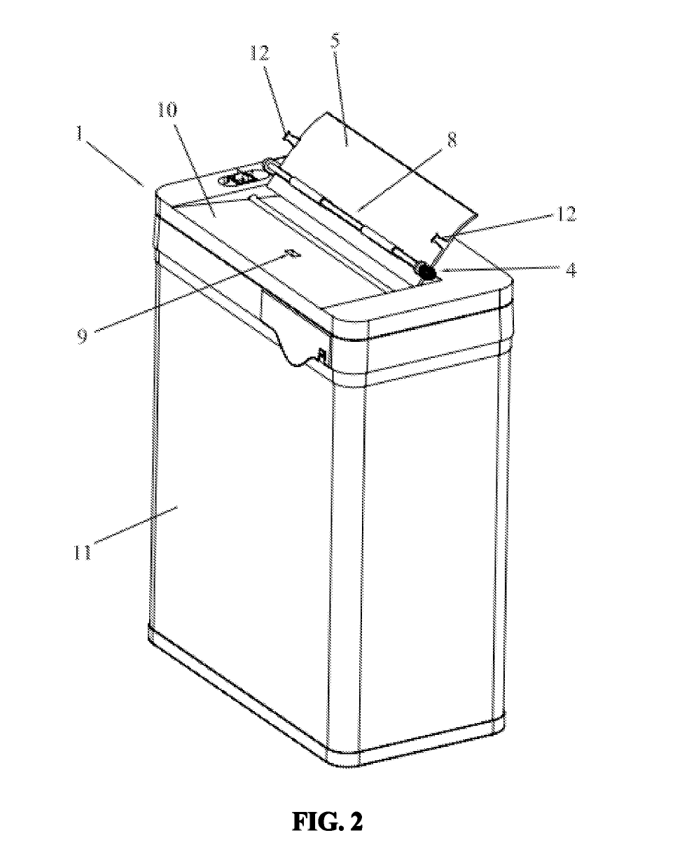

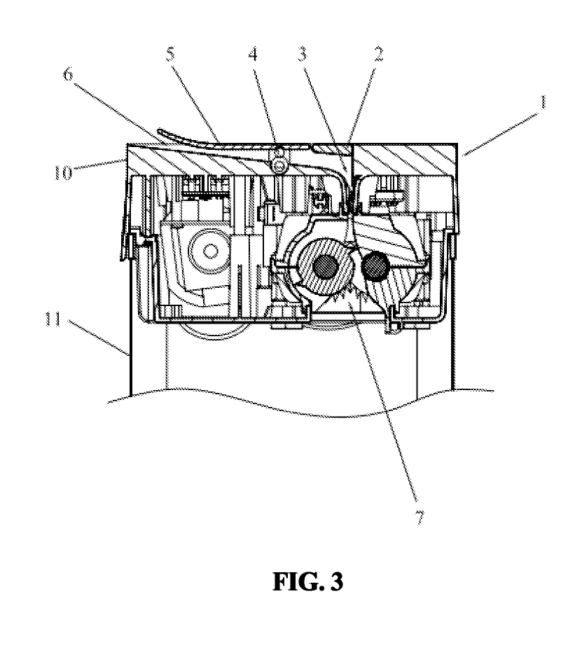

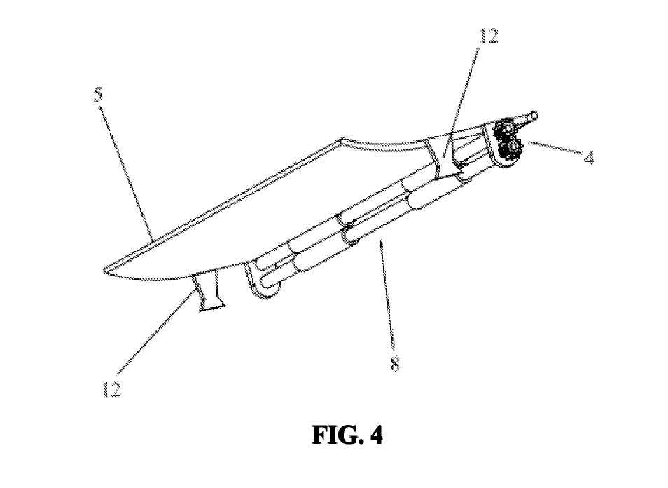

As shown in FIGS. 1-4, a horizontally-fed shredder with turnover cover, in accordance with the present invention, comprises a cutting head 1, a shredding slot 3 is disposed on the top of the cutting head 1, and cutters 7 are disposed under the shredding slot 3, wherein on the top of the cutting head 1 is disposed with a panel 10 and a turnover cover 5, the turnover cover 5 and the panel 10 form a paper entry 6 therebetween, the underside of said turnover cover 5 is disposed with a roller assembly 4 for paper feeding, the roller assembly 4 is located between the paper entry 6 and the shredding slot 3. The rear end of the turnover cover 5 is located over the shredding slot 3 proximate one side of the paper entry 6, above the shredding slot 3 is disposed a decorative plate 2 that is fixed on the top of the cutting head 1. A paper feeding detector switch 9, either in light-controlled type or mechanical type, is disposed at the paper entry 6 that is on the top of the cutting head 1. The turnover cover 5 that is on the top of the cutting head 1 is cooperatively arranged with a self-locking device 12, which is either in electrical type or mechanical type.

The working principles of the horizontally-fed shredder are described as follows: Before the horizontally-fed shredder is used, users can turn over the turnover cover 5 into a horizontal position. As the self-locking device 12 is cooperatively arranged on the turnover cover 5 and on the top of the cutting head 1, it will act to lock the turnover cover 5 when the turnover cover 5 is placed horizontally. At this point, the opening direction of the paper entry 6 faces transversely and the paper entry 6 connects with the shredding slot 3 while the turnover cover 5 is placed horizontally, therefore papers can be fed in a horizontal manner. When papers are fed in the paper entry 6 by hands, the paper feeding detector switch 9 begins to detect relative signals. The roller assembly 4 and cutters 7 that are controlled by the control circuit of paper shredders will act based on the obtained signals. Accordingly, papers are fed into the shredding slot 3 under the action of the roller assembly 4 and shredded by cutters 7. After papers are shredded, the fine pieces of paper will fall into a waste bin 11 under the cutting head 1. When paper obstruction or jamming occurs, users can release the self-locking device to unlock the turnover cover 5 and then turn it over to clear up the shredding slot 3.

Since horizontal paper feeding is adopted, the horizontally-fed shredder with turnover cover has low requirement on the spaces above it, making it still highly convenient for the horizontally-fed shredder to be used under some special circumstances such us under office tables. With such shredders, users can easily feed papers into the paper entry 6 in a horizontal manner and carry out shredding with little effort. In addition, the decorative plate 2 can cover the shredding slot 3 while paper shredding is in progress, so that ties, hairs or fingers will not be pulled into the shredding slot 3. In this way, potential safety hazards are largely reduced and shredder safety is improved, and meanwhile it is capable of effectively preventing paper obstruction or jamming and has people-oriented design.

Further, in accordance with example 1, the front end of said turnover cover 5 is an arc-shaped end bending upwards, which broadens the paper feeding spaces at the front end of the paper entry 6 and enables papers to be quickly and easily fed into the paper entry 6.

Further, in accordance with example 1, the upper surface of said panel 10 inclines downwards from the paper entry 6 to the shredding slot 3, so that papers can be easily fed into the shredding slot 3.

Further, in accordance with example 1, said roller assembly 4 is composed of two rollers drivingly connected via a gear mechanism 4, both ends of the two rollers are axially connected with the underside of the cover 5 and a dimensionally adjustable aperture is formed between the two rollers. By adjusting such aperture, paper thickness and number of sheets can be defined and flexible application is achieved.

Further, in accordance with example 1, said decorative plate 2 is a transparent or semi-transparent plate, so is the turnover cover 5. Because the decorative plate 2 and cover 5 are made of transparent or semi-transparent materials, it is helpful for users to observe paper feeding and find problems such as paper obstruction and jamming.

### Example 2

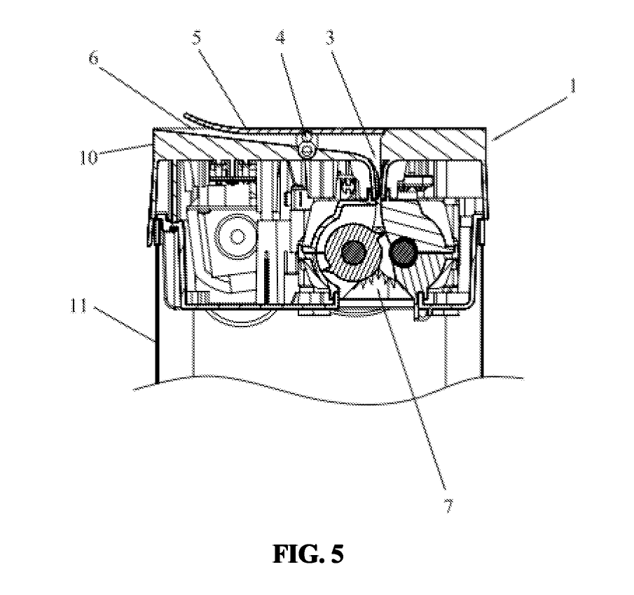

As shown in FIG. 5, the difference between example 2 and example 1 is that the horizontally-fed shredder with turnover cover in this example has no decorative plate 2 disposed above the shredding slot 3. However, the rear end of the turnover cover 5 is disposed above the shredding slot 3. When the turnover cover 5 is placed horizontally and the shredding is in progress, the shredding slot 3 will be covered by the rear end of the turnover cover 5, therefore ties, hairs and fingers can also be prevented from being pulled into the shredding slot 3. Consequently, potential safety hazards are largely reduced and shredder safety is improved.

### Example 3

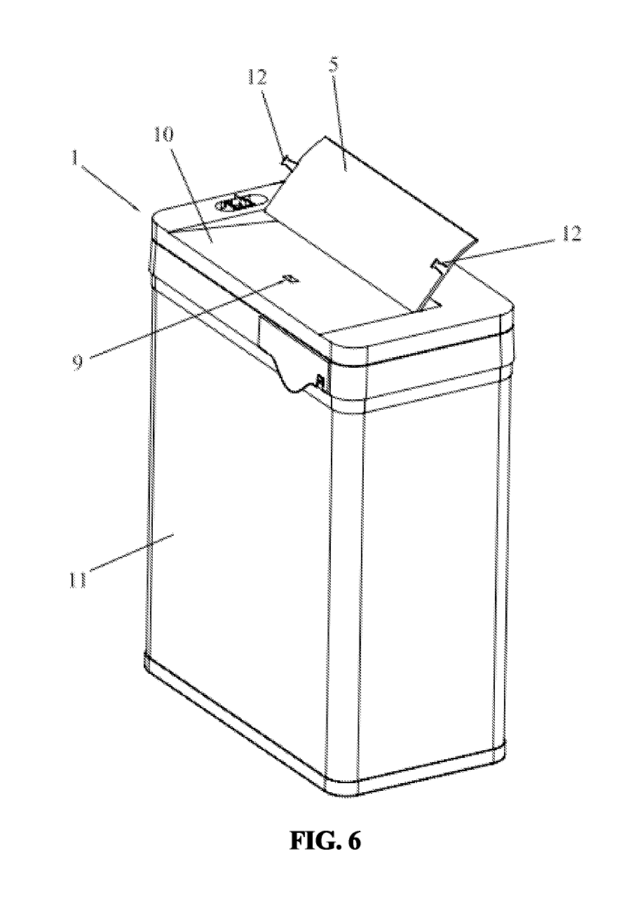

As shown in FIG. 6, the difference between example 3 and example 1 is that the horizontally-fed shredder with turnover cover has no roller assembly 4 disposed on the underside of the turnover cover 5. However, papers can be directly fed from the paper entry 6 to the shredding slot 3, so that convenience and safety of the shredder can also be achieved.

The aforementioned embodiment is only an example of the invention and shall not be used to restrict the implementation and the scope of claim of the invention, all changes and modifications made without departing from the invention in its broader aspects are deemed to be within the applied scope of the invention.

1. A horizontally-fed shredder with turnover cover comprising:
a cutting head (1),
a shredding slot (3) is disposed on the top of the cutting head (1),
cutters (7) are disposed under the shredding slot (3),
wherein on the top of the cutting head is disposed with a turnover cover (5), and
the turnover cover (5) and the top of the cutting head (1) form a paper entry (6) therebetween, which connects the shredding slot (3).

2. The horizontally-fed shredder with turnover cover according to claim 1, wherein the rear end of the turnover cover (5) is located over the shredding slot (3) proximate one side of the paper entry (6), and above the shredding slot (3) is disposed with a decorative plate (2) that is fixed on the top of the cutting head (1).

3. The horizontally-fed shredder with turnover cover according to claim 2, wherein said decorative plate (2) is a transparent or semi-transparent plate.

4. The horizontally-fed shredder with turnover cover according to claim 1, wherein the rear end of the turnover cover (5) is disposed over the shredding slot (3).

5. The horizontally-fed shredder with turnover cover according to claim 1, wherein the front end of the turnover cover (5) is an arc-shaped end bending upwards.

6. The horizontally-fed shredder with turnover cover according to claim 5, wherein the top of the cutting head (1) is disposed with a panel (10), the cover (5) and the panel (10) form the paper entry (6) therebetween, and the upper surface of the panel (10) inclines downwards from the paper entry (6) to the shredding slot (3).

7. The horizontally-fed shredder with turnover cover according to claim 1, wherein the underside of said turnover cover is disposed with a roller assembly (4) for paper feeding, the roller assembly (4) is located between the paper entry (6) and the shredding slot (3) and it is composed of two rollers drivingly connected via a gear mechanism (4), both ends of the two rollers are axially connected with the underside of the turnover cover (5), and a dimensionally adjustable aperture is formed between the two rollers.

8. The horizontally-fed shredder with turnover cover according to claim 1, wherein the turnover cover (5) and on the top of the cutting head (1) is cooperatively arranged with a self-locking device (12).

9. The horizontally-fed shredder with turnover cover according to claim 8, wherein a paper feeding detector switch (9) is disposed at the paper entry (6) that is at the top of the cutting head (1).

10. The horizontally-fed shredder with turnover cover according to claim 1, wherein said cover (5) is transparent or semi-transparent plate.

11. The horizontally-fed shredder with turnover cover according to claim 2, wherein said cover (5) is transparent or semi-transparent plate.

12. The horizontally-fed shredder with turnover cover according to claim 3, wherein said cover (5) is transparent or semi-transparent plate.

13. The horizontally-fed shredder with turnover cover according to claim 4, wherein said cover (5) is transparent or semi-transparent plate.

14. The horizontally-fed shredder with turnover cover according to claim 5, wherein said cover (5) is transparent or semi-transparent plate.

15. The horizontally-fed shredder with turnover cover according to claim 6, wherein said cover (5) is transparent or semi-transparent plate.

16. The horizontally-fed shredder with turnover cover according to claim 7, wherein said cover (5) is transparent or semi-transparent plate.

17. The horizontally-fed shredder with turnover cover according to claim 8, wherein said cover (5) is transparent or semi-transparent plate.

18. The horizontally-fed shredder with turnover cover according to claim 9, wherein said cover (5) is transparent or semi-transparent plate.
